(19) United States
(12) Patent Application Publication
(10) Pub. No.: US 2004/0266476 A1
(43) Pub. Date: Dec. 30, 2004

(54) Communications interface device

(76) Inventor: Thomas Bradford Hogan, Fishkill, NY (US)

Correspondence Address: WIGGIN AND DANA LLP, ATTENTION: PATENT DOCKETING, ONE CENTURY TOWER, P.O. BOX 1832, NEW HAVEN, CT, 06508-1832, US

(21) Appl. No.: 10/607,105

(22) Filed: Jun. 25, 2003

(51) Int. Cl. H04M 1/00

(52) U.S. Cl. 455/552.1

(57) ABSTRACT

The device of the present invention is a portal or communication interface device that allows for the connection of a wireless device to a HAN or LAN or other suitable network to provide communication services. The device facilitates that use of an end user device (i.e. a mobile phone) as a back end device or portable central office (PCO). Thus, the mobile telephone is portable central office (PCO) that, when connected to the device or portal of the present invention which is acting as a Personal Exchange (PEX), allows for communications services through a network at a premises. The portal also connects to a common electrical outlet (i.e. 110 Vac) so as to supply power for charging the wireless telephone battery and for generating a typical communications voltage. The device could also provide power to various network elements or devices.

### FIELD OF THE INVENTION

This invention relates generally to voice and data communications via wireless network and more particularly to an interface device or portal for providing wireless voice and data communications network connectivity to a home or local area network by connection of the portal to premises telephone wiring and to a wireless communication device.

### INCORPORATION BY REFERENCE

The following patent documents are hereby incorporated by reference: U.S. Pat. No. 6,141,356 issued to Gorman on Oct. 31, 2000; U.S. Pat. No. 6,414,952 issued to Foley on Jul. 2, 2002; U.S. Pat. No. 6,512,751 issued to Struhsaker et al. on Jan. 28, 2003; and U.S. Pat. No. 6,580,785 issued to Bremer et al. on Jun. 17, 2003. The following non-patent literature is hereby incorporated by reference: Cisco—Voice Networking Signaling and Control (See www.cisco.com/warp/public/788/signalling/net_signal_control.pdf).

### BACKGROUND OF THE INVENTION

Plain Old Telephone System (POTS)

FIG. 1 is a simplified block diagram of a conventional plain old telephone system (POTS) including central office (CO) wire centers and user premises layout of the prior art. Referring now in detail FIG. 1 illustrates a typical plain old telephone system (POTS) networks, such as for example a telephone company network, including data communication modems, numerous user premises 1 through N, wherein each user premises is connected to a CO wire center, via a subscriber line. Each subscriber line is connected to the user premises, which further connects to a user premises line, for distribution of POTS or Telephone Company wired service throughout the user premises. Usually, there are numerous POTS devices such as telephones, fax machines, personal computers (PCs), and the like, connected to each user premises line. Additionally, it is possible to have multiple subscriber lines connected to each user premises (not shown), thereby creating for example two separate user premises lines within each user premises'.

FIG. 2 illustrates another typical plain old telephone system (POTS) networks including data communication DSL modems. The data communication DSL modems include the apparatus and methods for enabling the simultaneous multiple telephone type services on a single line.

FIG. 2 illustrates that a variety of services may be connected at the CO wire center. These services may include digital telephone services, Internet television, audio and multimedia, fax, graphic services, high-speed Internet services, high-speed land services, Internet telephone service, stereo/audio service, power meter reading, home management and security services. Again, the operation of such services are generally understood and are further not necessary in order to describe the present invention. As further illustrated in FIG. 2, the prior POTS voice devices of the prior art telephone and standard fax machine, establish communications on a first transmission frequency band. A second transmission frequency band is defined at a higher frequency level than the POTS frequency band and can be used in the transmission of digital subscriber line (DSL) communications that provides multiple access techniques. The DSL modems provide both the physical layer and higher layer functions as needed to provide the simultaneous multiple access. Other methods of providing multiple access, such as frequency division multiplexing or other multiplexing techniques, may be utilized with some limitation in overall performance. The different equipment devices at the user premises can be identified and accessed by a multiple access code (MAC) address as determined by the DSL modem, or by the assigned available frequency range within the bandwidth of the communication.

FIG. 3 is a simplified block diagram illustrating a typical home area network (HAN) using installed POTS wiring. The HAN illustrated in FIG. 3 includes existing (installed) plain old telephone service (POTS) wiring, network clients (personal computer), computer port side of modem and fax. POTS wiring provides wiring infrastructure used to network multiple network clients (1 through N) at a customer premises. POTS wiring can be conventional unshielded twisted pair (UTP) wire that is generally routed internally in the walls of the customer (i.e. telephone company customer) premises such as, a house or business to various locations (e.g., rooms or offices) within customer premises. Other suitable types of wire are also available including Cat5e. Subscriber loop (also called a “local loop”) is a physical wiring link that directly connects an individual customer premises to the central office. Subscriber loop can be unshielded twisted pair (UTP) wire or other suitable cable. UTP wire causes signal attenuation over extended distances. This attenuation is greater for higher frequency signals. To accommodate the constraints imposed by the electrical properties of subscriber loop, subscriber loop line lengths are generally confined to a length no greater than 18 kilometers, although longer line lengths are sometimes used. Nonetheless, generally subscriber loop is not well suited to transmit signals greater than 1.1 MHz.

Customer premises is a subscriber premises (i.e. telephone company customer) that has arranged (generally for a monthly telephone service fee or for a per calling minute fee) with a local provider (such as a local telephone company) for a connection to a central office. A central office is a central telephone office (also called a local exchange or Central Office (CO) Wire Center as shown in FIGS. 1 and 2) that provides local switching and non-local switching (via the Public Switched Telephone Network (PSTN)). The telephone company wiring/equipment starts at the demarcation point (Telephone Network Interface) and connection to subscriber/local loop shown in FIG. 3. The customer premises' is illustrated by the network connected to the UTP wiring in FIG. 3.

A network client can be, for example, a personal computer equipped with a network interface card (not shown). It should be understood, however, that the principles of the typical network of FIG. 3 apply to home area networks (HANs) including other types of network clients such as specific purpose computers, computer appliances, computer-enabled devices or other types of network devices.

In addition to providing connectivity (e.g., networking) among network clients, POTS wiring connects to conventional POTS-compatible POTS on telecommunications devices (such as telephones, modem and facsimile machine). POTS wiring thus additionally couples telephone and modem to a central office via subscriber loop. The central office, in turn, connects the POTS-compatible devices to another POTS-compatible device located off premises.

Thus, one of the problems of the prior art is that there is no interface available for providing wireless service to a traditionally wired plain old telephone system in a HAN or LAN environment or other suitable configuration or structure. Another problem is that traditional POTS service is not available to all HANs or LANs. The present invention provides an interface device that will overcome these problems.

### SUMMARY OF THE INVENTION

The device of the present invention is a portal or communication interface device that allows for the connection of a wireless device to a HAN or LAN or other suitable network to provide communication services. The device facilitates that use of an end user device (i.e. a mobile phone) as a back end device or portable central office (PCO). Thus, the mobile telephone is portable central office (PCO) that, when connected to the device or portal of the present invention which is acting as a Personal Exchange (PEX), allows for communications services through a network at a premises. The portal also connects to a common electrical outlet (i.e. 110 Vac) so as to supply power for charging the wireless telephone battery and for generating a typical communications voltage. The device could also provide power to various network elements or devices.

An advantage of the present invention is that it could allow a wireless user to use one communication device for travel and for providing home or business based communications. Another advantage of the present invention is that it allows for wireless interface to HANs and LANs where wire POTS systems are not available. Another advantage of the present invention is that while connected to the wireless device it allows the device battery to be charged while also providing communications signals to the HAN or LAN or other suitable network. Another advantage is that the portal acts as a local exchange to initialize activation of the wireless telephone for communication between a network and the wireless device. In this configuration the portal acts as a portable exchange (i.e. PBX) and the mobile phone acts as a transportable/portable central office (PCO). Another advantage of the present invention is that the portal generates a typical telephone communications voltage (i.e. 48Vdc) to power the local loop (i.e. POTS network). Other advantages of the invention will in part be obvious and will in part be apparent from the specification. The aforementioned advantages are illustrative of the advantages of the present invention.

### DESCRIPTION OF THE DRAWINGS

In describing the present invention, features of the invention are not necessarily shown to scale. Also, reference will be made herein to FIGS. 1-8 of the drawings in which like numerals refer to like features of the invention and in which:

FIG. 1 is a simplified block diagram of a conventional plain old telephone system (POTS) including central office wire centers and user premises layout of the prior art;

FIG. 2 is a simplified block diagram of another conventional plain old telephone system (POTS) with networks including data communication DSL modems;

FIG. 3 is a simplified block diagram illustrating a typical home area network (HAN) using installed POTS wiring and connected to a central office (CO) which supplies telephone service to the home area network;

FIG. 3a is a simplified block diagram illustrating a typical home area network (HAN) using installed POTS wiring and connected to a central office (CO) which supplies telephone service to the home area network and also connected to a wireless network via an embodiment of the communication interface device of the present invention;

FIG. 3b is a simplified block diagram illustrating a typical home area network (HAN) using installed POTS wiring and connected to a wireless network via an embodiment of the communication interface device of the present invention which supplies telephone service to the home area network;

FIG. 4 is a simplified diagram of an embodiment of an exemplary wireless telecommunications network including a block diagram of a mobile station that is constructed and operated in accordance with this invention which can be used with to transmit and receive signals to and from the device of the present invention;

FIG. 5 is an elevational view of the mobile station shown in FIG. 4, and which further illustrates a cellular communication system to which the mobile station is bidirectionally coupled through wireless RF links;

FIG. 6a is a block diagram of an embodiment of the communications interface device (portal) of the present invention;

FIG. 6b is a block diagram of another embodiment of the communications interface device (portal) of the present invention;

FIG. 6c is a block diagram of a typical RJ45 modular connector shown in FIG. 6;

FIG. 6d is a block diagram of a typical RJ45 modular connector shown in FIG. 6;

FIG. 7a is a simplified block diagram of an exchange (PBX) illustrating a PBX connected to a Central Office (CO); and

FIG. 7b is a simplified block diagram of the portal of the present invention acting as an interface/exchange (PBX) and connected to a wireless device/telephone acting as a Portable Central Office (PCO).

FIG. 8 represents a simplified embodiment of the present invention being used by User A at a premises and User B in transit.

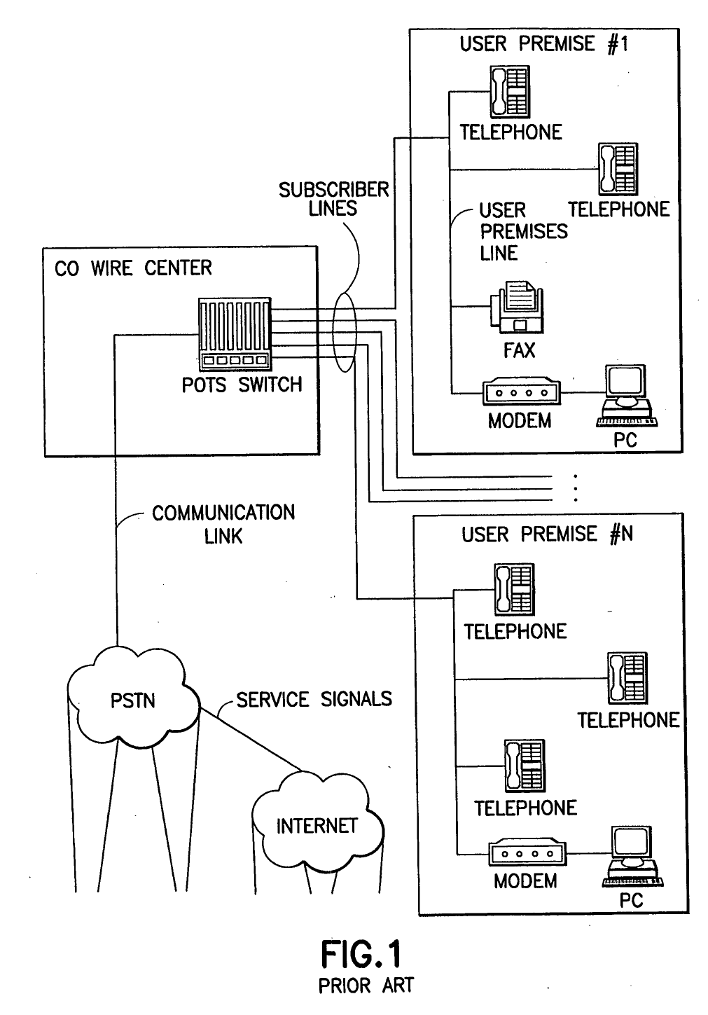

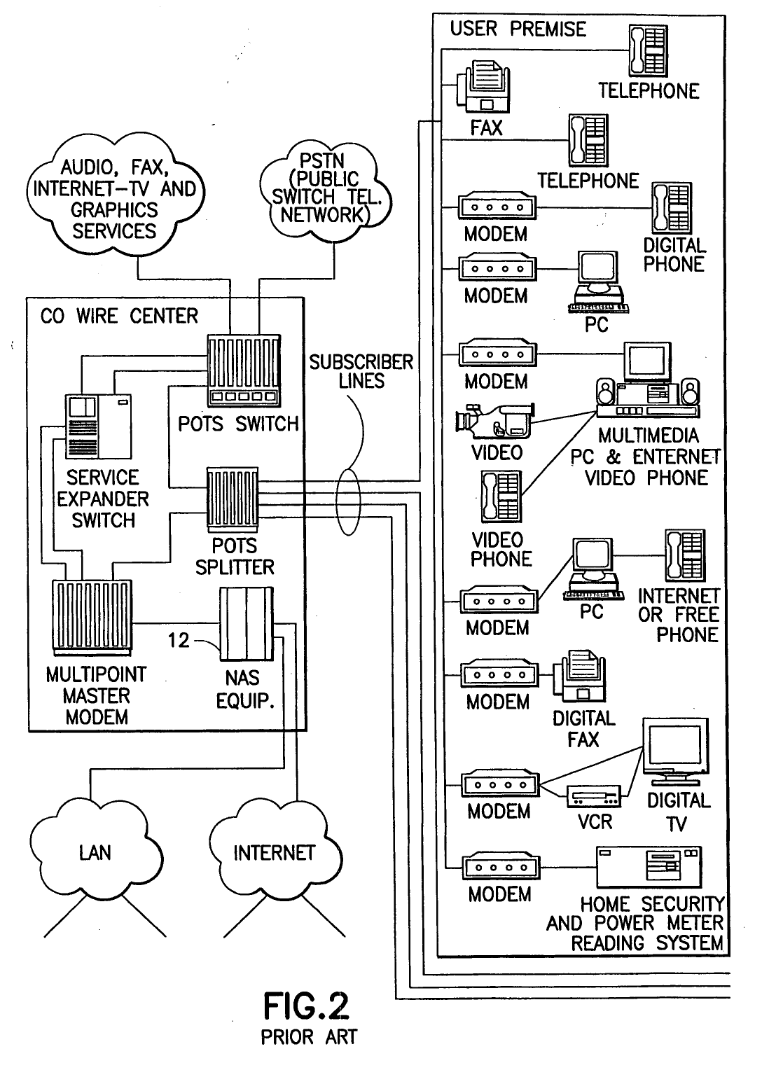

### DETAILED DESCRIPTION OF THE PRESENT INVENTION

The present invention overcomes the disadvantages of the prior art by providing a mobile central office and personal exchange to a premises'. Another advantage is that the areas not served by wired telecommunications service could obtain wireless telecommunication service to a premises' through the use of the PCO and PEX components of the present invention.

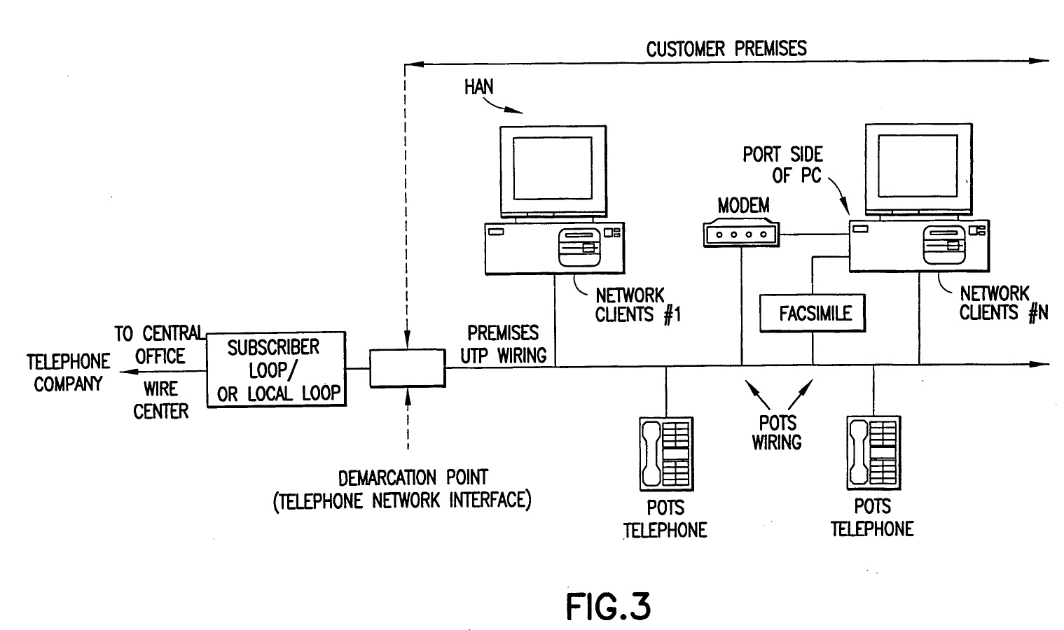

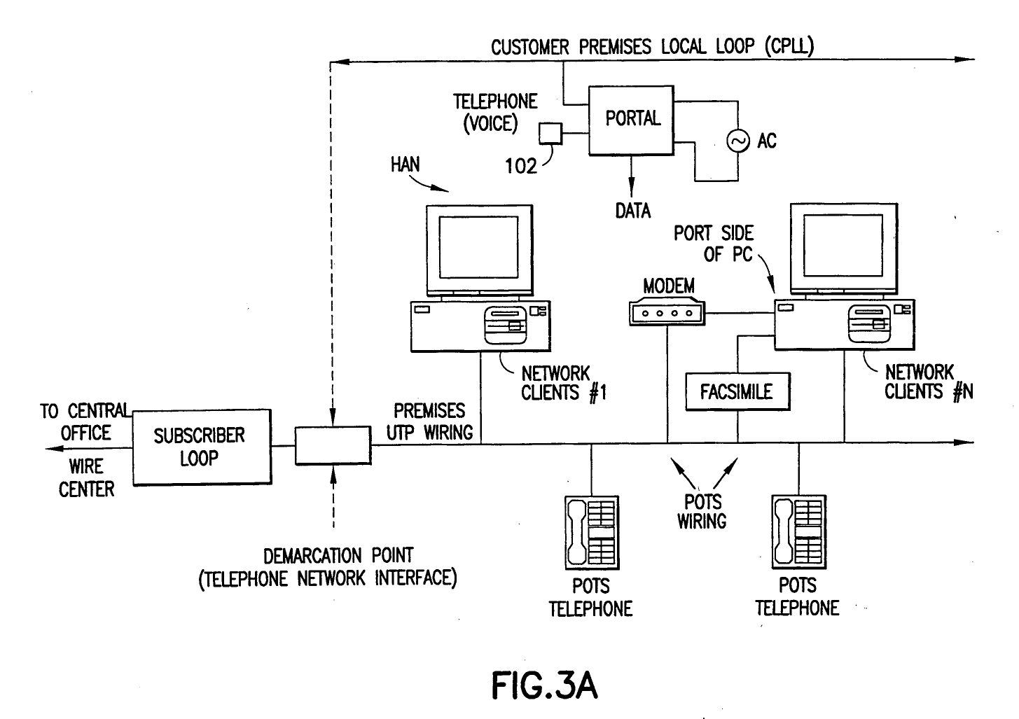

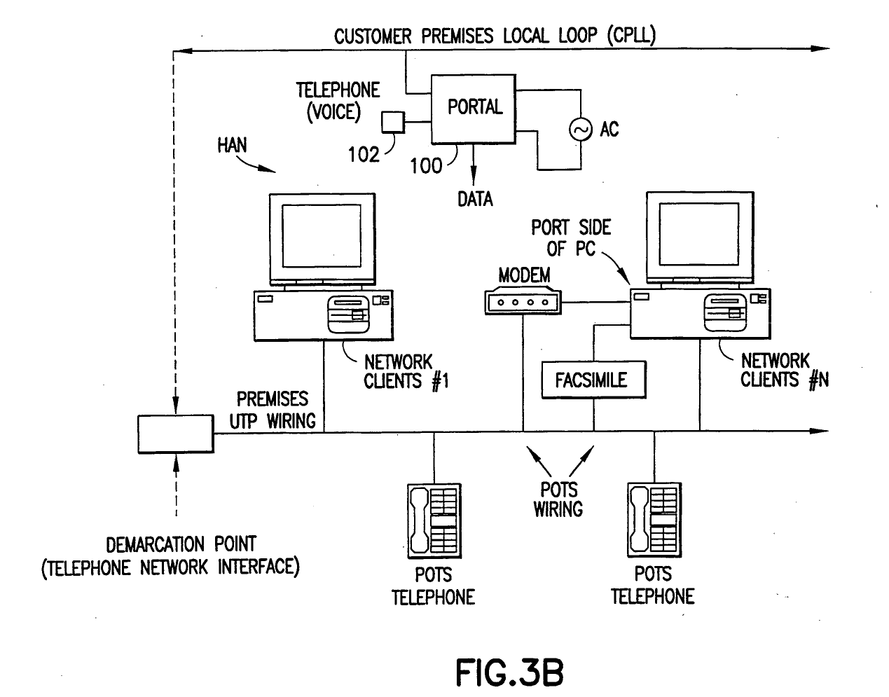

Communications Interface Device. FIG. 3a is a simplified block diagram illustrating a typical home area network (HAN) using installed POTS wiring and connected to a central office (CO) which supplies telephone service to the home area network and is also connected to a wireless network via an embodiment of the communications interface device 10 of the present invention. In the configuration of FIG. 3a, the home area network POTS wiring will transmit and receive signals to and from both the telephone company central office one line of a two-line system and via backfeed from the wireless network on a second line of the two-line system. The system of FIG. 3a is a multi-line network (i.e. two-line system with each line having two wires or twisted pairs). The wireless network as shown in FIG. 3b is a simplified block diagram illustrating a typical home area network (HAN) using installed POTS wiring and connected to a wireless network via an embodiment of the communications interface device of the present invention which supplies telephone service to the home area network. FIG. 3b is a single-line back-feed system. At the point of demarcation, the wired system is disconnected from the Telephone Company or Public Switched Telephone Network (PSTN). It should be noted that the wiring for the home or business is not limited to POTS wiring and that POTS wiring is used herein for illustrative purposes. Other suitable wiring can be used including, but not limited to Cat5e cable.

Wireless Communications

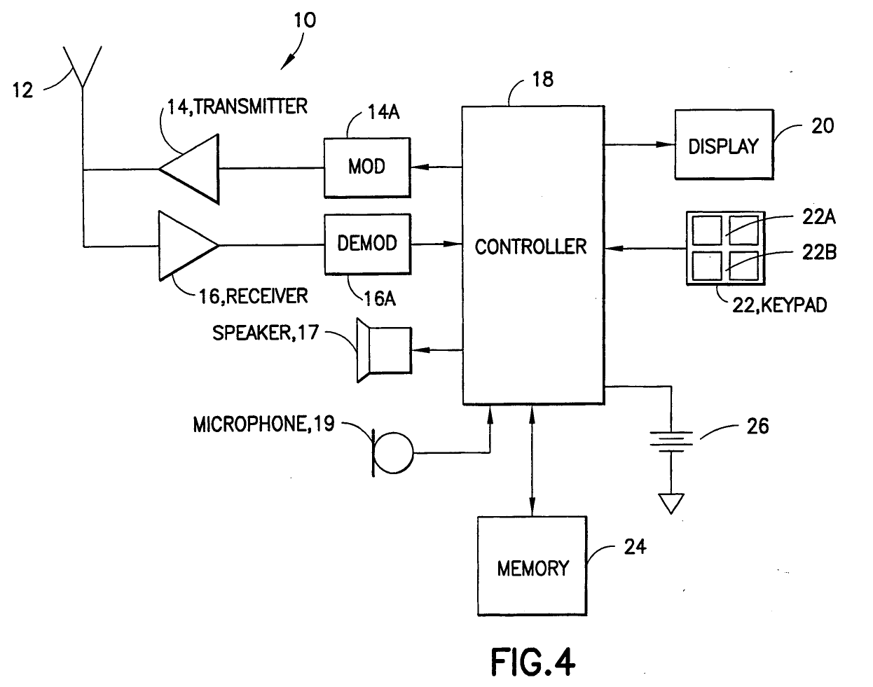

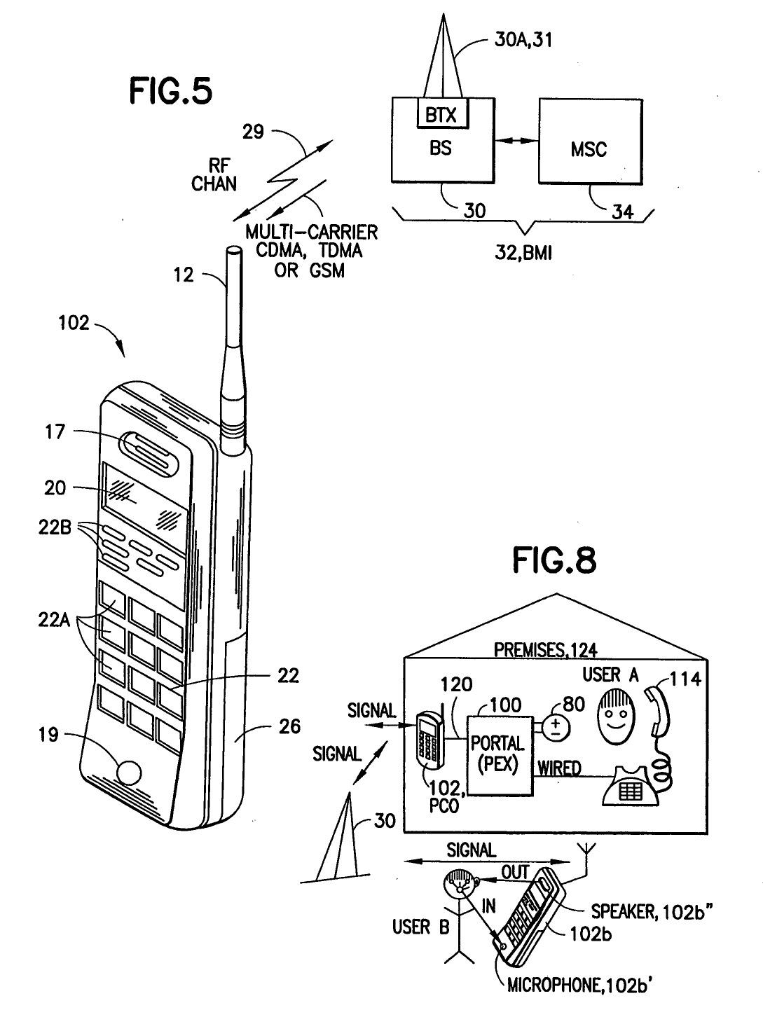

FIG. 4 is a simplified diagram of an embodiment of an exemplary wireless telecommunications network including a block diagram of a mobile station that is constructed and operated in accordance with this invention which can be used with to transmit and receive signals to and from the device of the present invention. FIG. 5 is an elevational view of the mobile station shown in FIG. 4, and which further illustrates a cellular communication system to which the mobile station is bidirectionally coupled through wireless RF links. The details of FIGS. 4 and 5 are described next.

Reference is made to FIGS. 4 and 5 for illustrating a wireless user terminal or mobile station 102, such as but not limited to a cellular radiotelephone or a personal communicator that is suitable for practicing the present invention. The mobile station 102 includes an antenna 12 for transmitting signals to and for receiving signals from a base site or base station 30. The base station 30 is a part of a cellular network comprising a Base Station/Mobile Switching Center/Interworking function (BMI) 32 that includes a mobile switching center (MSC) 34. The MSC 34 provides a connection to landline trunks when the mobile station 102 is involved in a call.

The mobile station includes a modulator (MOD) 14A, a transmitter 14, a receiver 16, a demodulator (DEMOD) 16A, and a controller 18 that provides signals to and receives signals from the transmitter 14 and receiver 16, respectively. These signals include signaling information in accordance with the air interface standard of the applicable cellular system, and also user speech and/or user generated data. The air interface standard is assumed for this invention to include a physical and logical frame structure of a type that was described above, although the teaching of this invention is not intended to be limited only to this specific structure, or for use only with an IS-136 compatible mobile station, or for use only in TDMA (Time Division Multiple Access) type systems. Other systems could be CDMA (Code Division Multiple Access), GSM (Global System for Mobile Communications) or other commercial wireless standard for mobile communications.

It is understood that the controller 18 also includes the circuitry for implementing the audio and logic functions of the mobile station. By example, the controller 18 may be comprised of a digital signal processor (DSP) device, a microprocessor device, and various analog to digital converters, digital to analog converters, and other support circuits. The control and signal processing functions of the mobile station are allocated between these devices according to their respective capabilities.

It should be realized that in other embodiments, the mobile station 102 may function only as a data terminal for at least one of transmitting or receiving packet data. The mobile station 102 which functions as a data terminal can include a data port 28 which is coupled to the controller 18. As a data terminal, certain of the user interface components described above may not be included. It should also be appreciated that in some embodiments the mobile station 102 may not be mobile at all, but may be operated at a fixed location (for example, as a component of a wireless facsimile machine in an office environment).

The mobile station 102 also includes various memories, shown collectively as the memory 24, wherein are stored a plurality of constants and variables that are used by the controller 18 during the operation of the mobile station. For example, the memory 24 may store the values of various cellular system parameters and the number assignment module (NAM). An operating program for controlling the operation of controller 18 is also stored in the memory 24 (typically in a ROM device). The memory 24 may also store packet data prior to transmission or after reception. The memory 24 can be used for storing routines that may be needed for implementing embodiments of the present invention as may be determined by one of ordinary skill in the art.

Packet data service options provide a mechanism of establishing and maintaining traffic channels for packet data service. A packet data service option is negotiated during call origination or at a later time during a call. The details of establishing packet data service can be found in, by example, IS-95A, IS-657, and IS-99:

Referring to FIG. 5, mobile station 102 is illustrated including a user interface that comprises a conventional earphone or speaker 17, a conventional microphone 19, a display 20, and a user input device, typically a keypad 22, all of which are coupled to the controller 18. The keypad 22 includes the conventional numeric (0-9) and related keys (for example, # and *) 22a, and other keys 22b used for operating the mobile station 102. These other keys 22b may include, by example, a SEND key, various menu scrolling and soft keys, and a PWR (power) key. The mobile station 102 also includes a battery 26 for powering the various circuits that are required to operate the mobile station.

The mobile station 102 also includes various memories, shown collectively as the memory 24, wherein are stored a plurality of constants and variables that are used by the controller 18 during the operation of the mobile station. For example, the memory 24 stores the values of various cellular system parameters and the number assignment module (NAM). An operating program for controlling the operation of controller 18 is also stored in the memory 24 (typically in a ROM device). The memory 24 may also store data, including user messages, that is received from the BMI (Base Station/Mobile Switching Center/Interworking) function 32 prior to the display of the messages to the user.

It should be understood that the mobile station 102 can be a vehicle mounted or a handheld device. It should further be appreciated that the mobile station 102 can be capable of operating with one or more air interface standards, modulation types, and access types. By example, the mobile station may be capable of operating with any of a number of other standards besides IS-136, such as GSM and IS-95 (CDMA). Narrow-band AMPS (NAMPS), as well as TACS (Total Access Communication System), mobile stations may also benefit from the teaching of this invention, as should dual or higher mode phones (e.g., digital/analog (IS-41) or TDMA/CDMA/analog phones). It should thus be clear that the teaching of this invention is not to be construed to be limited to any one particular type of mobile station or air interface standard. The operating program in the memory 24 includes routines to present messages and message-related functions to the user on the display 20, typically as various menu items.

Communications Interface Device/Portal

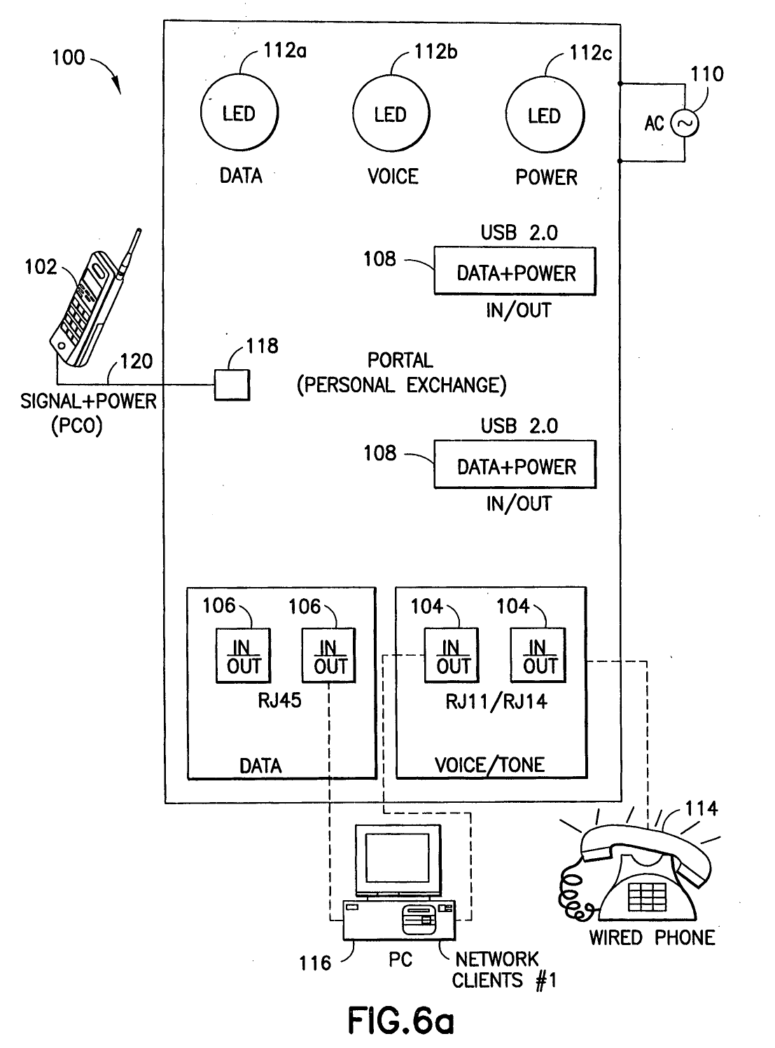

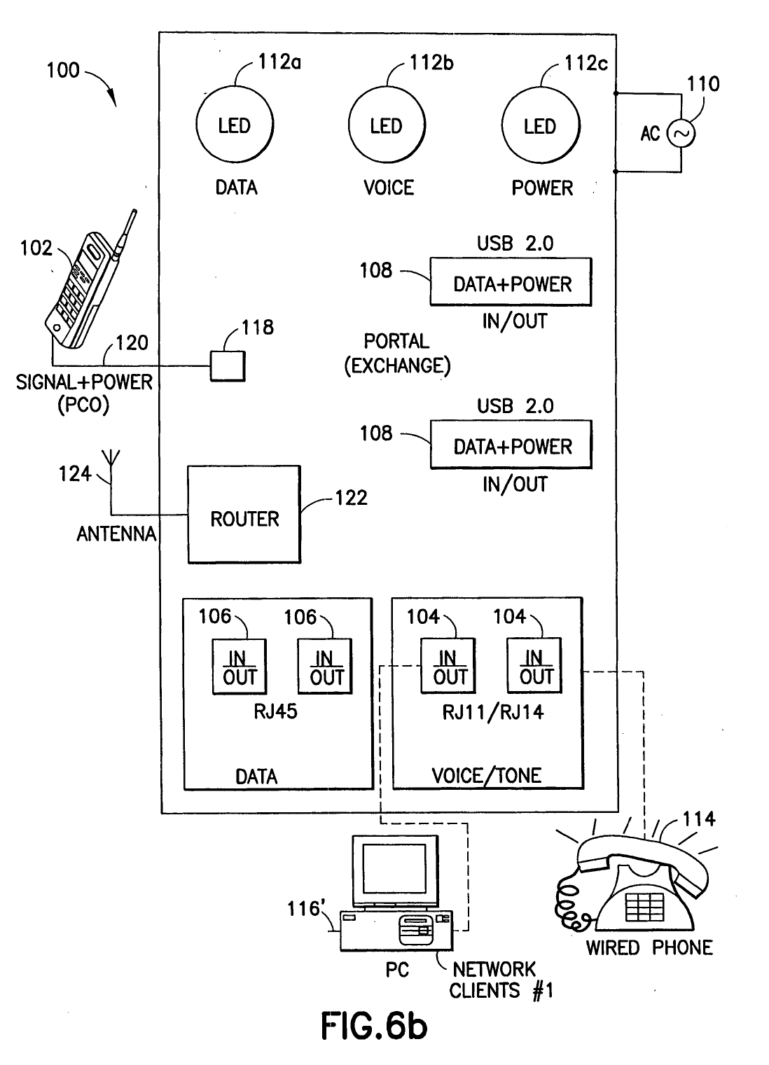

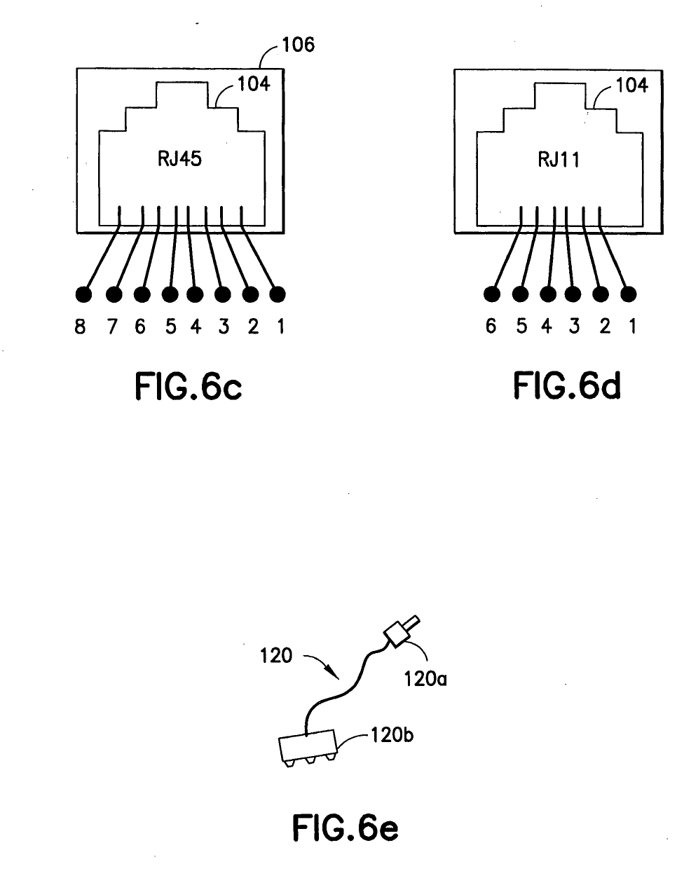

FIG. 6a is a block diagram of an embodiment of the communications interface device (portal) 100 of the present invention. The portal 100 can act as an exchange when connected to a wireless device 102 (also referred to herein with respect to the description of FIG. 5 as mobile station 102) such as a wireless telephone or mobile communication device (i.e. Blackberry). The portal could include one or more standard interconnection modules such as an RJ11 or RJ14 connector 103 used for tone signal communications, an RJ45 connector 106 used for data signal communications or a USB 1.0 or 2.0 connector 108 used for data and power communications. The portal 100 can be connected to an AC power supply (or alternately a portable power supply such as a DC battery bank). The power supply 110 provides power to the wireless communications device 102 for the purpose of charging the battery (not shown) of the device 102. The power supply can also supply power to various elements of the POTS network such as, for example, tone and/or USB powered devices including, but not limited to computers or peripherals (i.e. personal digital assistant).

In an embodiment of the present invention, the portal 100 could include one or more LEDs 112 to indicate data transfer 112a, presence of tone 112b, and/or presence of power 112c. FIG. 6a further illustrates a wired telephone 114 connected to the RJ11/RJ14 connector 104 as well as a PC 116 that is also connected to the RJ11/RJ14 connector 104. A data/power cord 120 comprising a portal connector 120a at a first end and a wireless device connector 120b at a second end. Preferably, the portal connector/receptical 118 is a universal female configuration and mates with the data/power cord 120 for most (or preferably all) wireless communication device 102 provided in order to be universally suitable for use with the multitude of wireless communication devices 102 available. The data/power cord 120 would also preferably be configured for the presented wireless communication device 102 with an appropriate male/pin configuration 120b for connection to a female connector (not shown) of the wireless communication device 112. It should be understood that while the male/female configuration described herein with respect to the data/power cord 120 and associated connectors is preferred, other configurations of connectors could be used as may be determined by one of ordinary skill in the art. FIG. 6c is a block diagram of a typical RJ45 modular connector 106 shown in FIG. 6a and FIG. 6d is a block diagram of a typical RJ11 modular connector 104 shown in FIG. 6a.

FIG. 6b is a block diagram of another embodiment of the communications interface device (portal) of the present invention. In the embodiment of FIG. 6b, a router with an antenna is added to the portal. The router is also referred to as an Access Point (AP) or Wireless LAN transmitter/receiver that acts as a connection between wireless clients and wired networks. Wi-fi or wireless fidelity is a term used to describe a type of network. Wi-fl generically refers to any type of 802.11 network with various 802.11 networks having specifications for specific frequency ranges and data transfer rates. The PC 116 of FIG. 6b can be configured with a wireless network interface card (NIC Card) 116′ and can communicate with the network through the router 122.

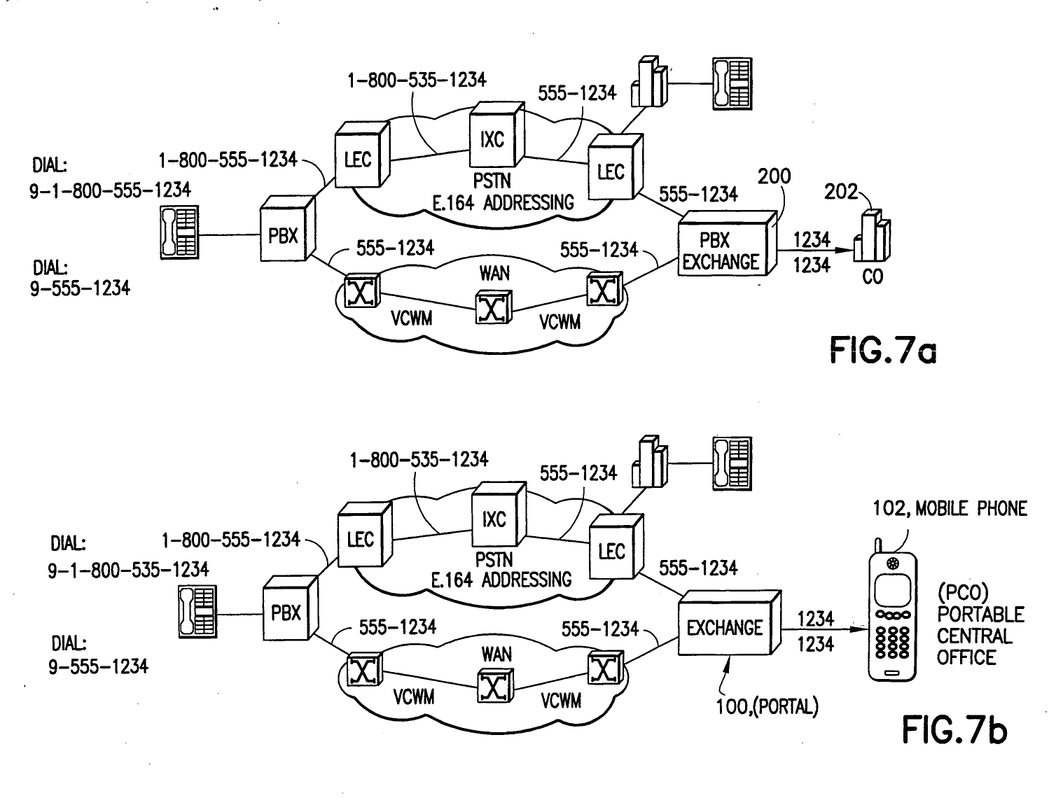

FIG. 7a is a simplified block diagram of a typical exchange 200 illustrating a PBX (Private Branch Exchange) connected to a Central Office (CO) 202. In contrast to FIG. 7a, FIG. 7b is a simplified block diagram of an embodiment of an implementation of the portal 100 of the present invention acting as an interface/exchange in the context of the present invention, referred to as Personal Exchange (PEX) and connected to a wireless device/telephone 102 acting as a Portable Central Office (PCO).

Power and Data. Referring to FIGS. 3a, 3b and FIGS. 6a and 6b, the portal 100 when attached to a power source 110 (preferably a 110Vac typical outlet) provides a typical telephone communications voltage (i.e. 48Vdc) through the use of a transformer (not shown and preferably integrated into the portal 100 package) to power the Customer Premises Local Loop (CPLL) (i.e. the customer premises plain old telephone system or POTS network). The voltage is applied to enable the transport of signal on the wiring. “The standard way to transport voice between two telephone sets is to use tip and ring lines. Tip and ring lines are the twisted pair of wires that connect to a wired telephone via, for example an RJ-11 connector.” (See Cisco—Voice Networking Signaling and Control, net_signal_control.pdf, available at www.cisco.com). Tip and ring refer to positive and negative leads, respectively.

FIG. 8 represents a simplified embodiment of the present invention being used by User A at a premises and User B in transit. The portal or PEX 100 is powered by 110Vac in premises 124. Telecommunication device 102 acting as a Personal Central Office (PCO) for premises 124 is connected to the portal 100 via cable 120. In the embodiment of FIG. 8, a telephone connection is made between wired telephone 114 User A and mobile telecommunication device 102a User B. The mobile telecommunication device 102a includes a microphone 102b′ and a speaker 102a′. The voice signal is transmitted between User B and User A from mobile telecommunication device 102a to communications tower 30 and then to PCO 102 at the Premises 124 where through portal/PCX 100 the voice signal is sent through the wired POTS system of the premises to wired telephone 114 and received by User A. In reverse, User A can send a voice signal back to User B.

Advantages of the embodiments of the present invention described herein include the ability to provide a mobile central office and personal exchange to a premises'. Another advantage is that the areas not served by wired telecommunications service could obtain wireless telecommunication service to a premises' through the use of the PCO and PEX. While the present invention has been disclosed and described with reference to a various embodiments thereof, it will be apparent, as noted above those variations and modifications may be made therein. It is, thus, intended in the following claims to cover each variation and modification that falls within the true spirit and scope of the present invention.

What is claimed is:

1. A communications interface device for providing telecommunications service to a plain old telephone system (POTS) network, the communications interface device comprising:
a receptical operatively connected to the communications interface device;
a cable, the cable comprising a first end and a second end and a signal conducting wire therebetween, the cable connected at the first end to the receptical;
a wireless telecommunication device comprising an antenna for transmitting and receiving wireless communication signals and a receptical connected to the second end of the cable and providing telecommunications signal to the communications interface device for distribution to the network;
a data port for sending and receiving data through the portal, the data port operatively connected to the communications interface device and the network; and
a tone port for sending and receiving tone through the portal, the data port operatively connected to the communications interface device and the network;
whereby a power supply provides power to the communications interface device in order to deliver telephone communications voltage to the network.

2. The device as claimed in claim 1 further comprising:
one or more indicators for providing indication of signals comprising data, voice and power.

3. The device as claimed in claim 1 whereby the power supply further provides power for charging the wireless communications device.

4. A communications interface system for use with a wireless telecommunication system and a premises' wired plain old telephone system (POTS) network, the communications interface system comprising:
a wireless telecommunications device for use as a portable central office (PCO); and
a portal operatively connected to the wireless communications device, the portal for use as a personal exchange (PEX);
whereby communications received by the wireless communications device is transmitted through the portal to peripheral devices connected to the premises' wired plain old telephone system (POTS).

5. The communications interface system of claim 4 further comprising a power supply for supplying power for telecommunications signal to the premises' plain old telephone system (POTS).

6. The communications interface device if claim 5 whereby the power supply further provides power for charging the wireless communications device.
